(19) United States
(12) Patent Application Publication
(10) Pub. No.: US 2025/0343250 A1
(43) Pub. Date: Nov. 6, 2025

(54) METALLIC BIPOLAR PLATE FOR AN ELECTROCHEMICAL SYSTEM

(71) Applicant: Reinz-Dichtungs-GmbH, Neu-Ulm (DE)

(72) Inventors: Michaela NEUSIGL, Schwendi (DE); Verena STECK, Weissenhorn (DE); Wolfgang BERROTH, Elchingen (DE); Volkan KANAL, Pfaffenhofen (DE); Sebastian SCHEELER, Stuttgart (DE); Felix SENF, Ulm (DE); André SPEIDEL, Schwendi (DE)

(21) Appl. No.: 19/179,993

(22) Filed: Apr. 15, 2025

(30) Foreign Application Priority Data
Apr. 16, 2024 (DE) 20 2024 101 888.5

(51) Int. Cl. H01M 8/0228; C25B 11/036; C25B 13/02; C25B 13/05; C25B 13/08; H01M 8/0206; H01M 8/0213; H01M 8/0221; H01M 8/0226; H01M 8/026

(52) U.S. Cl. CPC H01M 8/0228; C25B 11/036; C25B 13/02; C25B 13/05; C25B 13/08; H01M 8/0206; H01M 8/0213; H01M 8/0221; H01M 8/0226; H01M 8/026

(57) ABSTRACT

The present disclosure relates to a metallic bipolar plate for an electrochemical system, wherein the bipolar plate comprises two separator plates and each of the separator plates has a flow field, wherein at least one of the flow fields has a coating on at least one surface of the associated separator plate, at least in sections, wherein the coating comprises: at least 50% by weight and/or at most 95% by weight of a graphite-carbon black mixture, and at least 5% by weight and/or at most 31% by weight of one binder or of a combination of several binders.

### CROSS REFERENCE TO RELATED APPLICATION

This application claims priority to German Utility Model Application No. 20 2024 101 888.5, entitled “METALLIC BIPOLAR PLATE FOR AN ELECTROCHEMICAL SYSTEM”, filed Apr. 16, 2024. The entire contents of the above-identified application is hereby incorporated by reference for all purposes.

### TECHNICAL FIELD

The present disclosure relates to a metallic bipolar plate for an electrochemical system.

### BACKGROUND AND SUMMARY

Known electrochemical systems in which the metallic bipolar plate disclosed here can be used are, for example, fuel cell systems, flow batteries or electrochemical compressor systems, in particular electrolyzers. Known electrolyzers are configured, for example, in such a way that hydrogen and oxygen are generated from water by applying a potential and at least the hydrogen is present in compressed form. In addition, electrochemical compressor systems such as electrochemical hydrogen compressors are known, to which gaseous molecular hydrogen is fed and in which it is electrochemically compressed by applying a potential. In addition, known electrochemical systems include electrochemical separator systems in which, for example, hydrogen is extracted from one reaction system and enriched in another part of the electrochemical system.

Known electrochemical systems often comprise a stack of electrochemical cells, which are separated from each other by bipolar plates. Such bipolar plates may serve for example for indirectly electrically contacting the electrodes of the individual electrochemical cells (for example fuel cells) and/or for indirectly electrically connecting adjacent cells (series connection of the cells). In particular, the bipolar plates can have two separator plates. The separator plates or the bipolar plate can have or form a web-channel structure that is arranged to supply the cells with one or more media and/or to remove reaction products. The media may be fuels (for example hydrogen or methanol), reaction gases (for example air or oxygen) or coolants to conduct the waste heat generated during the conversion of electrical or chemical energy in the electrochemical cell. Such a web-channel structure is usually arranged in an electrochemically active area (so-called “flow field”) and in the distribution and collection regions leading to and from it. Furthermore, the bipolar plates can be sealed against each other and/or from the outside and to seal the various media channels, including the cooling channels. By way of example, the bipolar plates may have openings, through which the media to be fed and/or the reaction products can be routed towards or away from the electrochemical cells that are arranged between adjacent bipolar plates of the stack. All of the above statements concerning bipolar plates can in principle also apply to the bipolar plates disclosed herein or be provided for them.

The electrochemical cells may for example each comprise one or more membrane electrode assemblies (MEAs). The interior of the MEA consists of several layers, which will not be discussed further here. The MEA can have one or more electrically conductive gas diffusion layers (GDL), which are usually oriented towards the bipolar plates. Due to this proximity, they are explicitly considered here. The GDLs are usually designed as electrically conductive nonwoven materials, in particular metal or carbon nonwoven materials. The bipolar plates are usually composed of two separator plates, each of which adjoins a membrane electrode assembly, or to be more precise, its GDL. Bipolar plates for electrochemical systems usually have a large number of webs and channels arranged between the webs, which serve as the aforementioned web-channel structure, that is, as the flow field. To improve the electrical properties, these webs can be coated with graphite, for example. Graphite can be applied to the webs as a dispersion or suspension for this purpose. This is already known, for example, from DE 10 2004 009 869 A1 and DE 10 2007 055 222 A1.

However, it has been shown that unexpected and in particular premature performance losses of the electrochemical cell(s) or the electrochemical system can occur during operation of the electrochemical cells. In particular, it has been shown that the graphite-based coatings currently used do not exhibit sufficiently stable adhesion to the separator plate substrate. For example, ever higher demands are being made on the adhesion of the coatings, even in systems with changing materials of the MEA components, for instance the membrane itself or of auxiliary agents of the MEA. In addition, as a result of longer running times, for example, there are further risks of substances being introduced via the reagents, which can lead to premature performance losses if the coatings are unsuitable.

Based on this, it was therefore the task of the present disclosure to provide a metallic bipolar plate in which the risk of premature performance losses can be limited.

This object is at least partially achieved by the subject-matter disclosed herein.

In accordance with the present disclosure, it was recognized in particular that premature performance losses occurring to date may be at least partly due to the fact that the previous graphite coating on the webs of the electrochemically active area may be lost prematurely. For example, the graphite coating can detach prematurely from a bipolar plate, whereby a previously essentially closed surface can form capillaries, or alternatively the contact ratios between the coating and the bipolar plate substrate can change. The capillaries can enable substances carried in the reaction medium to penetrate in the direction of the bipolar plate substrate surface, i.e. into the interface between the coating and the substrate. The overall system, but in particular the bipolar plates (starting at an outer coating surface) can then exhibit reduced electrical conductivity, which leads to corresponding performance losses.

Accordingly, a metallic bipolar plate for an electrochemical system is proposed, wherein the electrochemical system can be designed in particular according to any of the above examples. The bipolar plate comprises two separator plates and each of the separator plates has a flow field, wherein at least one of the flow fields has a coating on at least one surface of the associated separator plate, at least in sections, and wherein the coating comprises:
at least 50% by weight and/or not more than 95% by weight of a graphite-carbon black mixture, and at least 5% by weight and/or at most 31% by weight of one binder or of a combination of several binders.

It has been shown that a coating with such a composition has improved durability and, in particular, improved resistance to premature detachment from the bipolar plate during operation of the electrochemical system. One possible explanation is that the binder(s) make it more difficult for water or other substances that may arise during the operation of the electrochemical system to penetrate, infiltrate and/or undermine the coating. The provision of the graphite-carbon black mixture also achieves the desired improvement in electrical properties and, in particular, conductivity. The addition of carbon black to graphite has proven to be particularly effective, as explained in more detail below. A total binder content of 15 to 28% by weight may be used. In some embodiments, mechanically delaminated graphite may be used.

Each of the separator plates can have two surfaces, in particular a first surface that faces the other separator plate and a second surface that faces away from the other separator plate. The first surface can form an inner side, which in particular delimits an optionally fluid-conducting and/or at least partially fluidically sealed interior of the bipolar plate. The second surface can form an outer side which, for example, is adjacent to a MEA of the type described above; in particular, it can be adjacent to a GDL. In a manner known per se, a flow field formed on a first one of the surfaces of a separator plate and, in particular, a channel-web structure encompassed by it can form a complementary channel-web structure on the other surface of the separator plate. The coating disclosed herein may be formed in particular or exclusively on a surface of the separator plate that forms one of the outer sides of the bipolar plate.

The separator plates may each comprise or consist of metal. They can be embossed and/or deep-drawn parts, for example. The channel-web-structure may not only be formed on the surface of the plate, but in the substrate as well. For example, the coating can be applied to the separator plate, for example immediately onto the metal substrate of the plate, in an initially fluid form, e.g. in a water-based system, and solidify there. According to embodiments, the coating can be applied in several layers, whereby each layer can be at least partially dried before a subsequent layer is applied. Once all layers have been applied, the entire coating can be cured.

According to one embodiment, the coating comprises at least two different binders and has a single-layer structure. For example, the coating may comprise exactly two different binders and be one-layered. For example, these binders can be distributed essentially homogeneously within the coating and/or the coating can have the same composition regardless of location. However, due to segregation processes and the like, it is also possible that the at least two different binders are inhomogeneously distributed in the one coating layer. In such a case, the coating can be applied and cured as a single layer in particular, which limits the manufacturing costs of the coated bipolar plate accordingly.

In general, both separator plates of a bipolar plate can be coated according to any of the variants described here, in particular on their respective outer sides or second surfaces. The coatings of the separator plates can be the same or different from each other.

According to one embodiment, the coating comprises at least two different binders and has at least two layers. A binder may be present in at least one of the layers and absent in one of the other layers. For example, in a two-layer coating, at least one first binder can be provided in the first layer, but not in the second layer, and a second binder can only be provided in the second layer, but not in the first layer. Furthermore, it may be provided in this context that each of the layers comprises exactly one binder. Such a two-layer coating can therefore have an inhomogeneous material composition at least to the extent that its layers can have different components and in particular different binders. In principle, it is also possible to have a first binder in the first layer and in the second layer, but different second binders in the two layers.

By means of a two-layer coating of the above type, the respective layers can be produced, for example, under conditions optimized for a respective binder. The provision of different binders can enable a combination of the specific advantages associated with a particular binder to improve the resistance and, in particular, the adhesion of the coating to the separator plate.

The layers can be arranged essentially congruent to one another, whereby, for example, side surfaces or end faces of the respective layers can be exposed. According to another embodiment, a lower layer in particular, which is in direct physical contact with the separator plate, is covered by the at least one further layer on all of its initially exposed surfaces. In other words, this lower layer can be completely shielded from the environment by the at least one further layer and/or embedded in the at least one further layer, whereby the further layer can also form contact surfaces with the separator plate. However, the lower layer may be covered to at least 80%, optionally at least 90%, optionally at least 95% of its surface by the further layer.

According to one embodiment, one of the binders is a thermoset or an amorphous first thermoplastic and the other binder is a second thermoplastic. For example, the second thermoplastic can be partially crystalline.

It has been shown that the task according to the present disclosure can be reliably solved with such a combination of different binders. One possible explanation is that by providing the second thermoplastic in particular, any fluid paths in the coating can be narrowed or closed to a greater extent, especially if the coating is heated to temperatures higher than the melting point of the thermoplastic, in particular of the second thermoplastic before the bipolar plate is installed. Optionally, in the situation where the first binder is thermoplastic, the second thermoplastic binder may have a lower melting temperature than the first binder. The temperature to which the coating is heated to is optionally selected below the melting temperature of the first binder and below the degradation temperature of the second binder. The coating at its interface to the metallic substrate may show no pores. As a result, water that reaches the coating can migrate through it to a lesser extent and in any case reach an interface with the separator plate substrate to a correspondingly reduced extent. The latter could otherwise accelerate the detachment of the coating from the separator plate. For example, the thermoset and/or the first amorphous thermoplastic may be selected to improve adhesion to the metal and/or adhesion between the graphite and carbon black particles, for example to an increased extent compared to the other binder.

If the coating is heated, a coating which has originally been applied as two layers may transform into a one-layered coating with at least two binders. To this end, it is advantageous if the binders are miscible one with another.

According to one embodiment, one of the binders comprises polyamide, PA, and the other binder comprises polyamide-imide, PAI. In particular, the binders can exclusively comprise PA or PAI. In general, PA or PAI can each be understood as a group of substances, so that the binders can also each comprise mixtures of different polyamides or mixtures of different polyamide-imides. More specifically, one of the binders may comprise or consist of at least one type of polyamide or a mixture of different polyamides. The corresponding other binder may in particular comprise or consist of at least one type of polyamide-imide or a mixture of different polyamide-imides. A mixture of different polyamides or a mixture of different polyamide-imides counts as a binder in the context of the present document. In view of a possible ban of certain coating materials incorporating components that contain fluorine, it is possible that the binders of the present coating are fully or essentially free of components that contain fluorine.

In the case of a structure having at least a two-layer coating, the uppermost or outermost layer, which comprises a large-area contact surface to the environment and in particular any adjacent gas diffusion layer, can comprise predominantly or exclusively PA as a binder, at least in the region of this contact surface. The lower layer, which comprises a contact surface to the separator plate, can, however, comprise predominantly or exclusively PAI as a binder, at least in the region of this contact surface. It has been shown that this can improve the electrical conductivity between the coating and the separator plate substrate, in particular during operation of the electrochemical system, but also suppress detachment of the coating from the separator plate substrate. However, a reverse sequence with PAI in the outermost layer and PA in the lowest layer can also be provided. Here, a layer of PA binder can be melted directly onto the separator plate substrate. In a contact area between the layers, localized mixing of the respective binders can occur, for example due to the first layer dissolving when the second layer is applied or when the entire coating melts.

According to one embodiment, the coating on the separator plate substrate contains at least 3 wt % and at most 30 wt % PAI. Alternatively or additionally, it contains at least 1 wt % and at most 12 wt % PA. Further binders can, but do not have to, be provided and/or the remaining portion of the coating can be formed by the graphite-carbon black mixture.

According to one embodiment, the coating comprises PAI as the thermoset or amorphous first thermoplastic and PA as the second thermoplastic. What was said above specifically for the PAI/PA combination can also apply to other combinations of thermoset or amorphous first thermoplastic on the one hand and second thermoplastic on the other.

For example, the proportion of the binder formed from a thermoset or an amorphous first thermoplastic—for example PAI—can make up ½ to ¾ of the total binder proportion in the entire coating, while the proportion of the second thermoplastic binder—for example PA—can make up ¼ to ½.

According to one embodiment, the graphite/carbon black mixture has a carbon black/graphite ratio of at least 1:1 up to and including 1:25, optionally up to and including 1:20. It has been shown that this can reliably improve the electrical conductivity of the coating in particular, for example because the conductive carbon black material can adhere to the surfaces of the similarly conductive graphite in its structural free spaces without filling them.

According to one embodiment, the graphite particles of the graphite-carbon black mixture are platelet-shaped. It is for instance possible to use mechanically delaminated graphite. Unlike platelet-shaped graphite particles, elongated fiber-like carbon structures and/or very thin individual graphene layers have proven unsuitable for the desired increase in electrical conductivity. The carbon black particles of the graphite-carbon black mixture are optionally essentially spherical.

According to one embodiment, the at least one flow field has a plurality of channels and webs extending between the channels and, in particular, separating the channels, the coating being applied at least to the webs and, in particular, at least to web crests, which make part of the webs or form the webs; and/or wherein at least channel bases of the channels are free of the coating. In this way, a defined channel geometry can be maintained in which the coating does not form any interfering contours that impede fluid flow and, in particular does not form any constrictions. Even with multi-layer coatings, the channel bases may be free from coating, even though the extent of the different coating layers does not have to be the same. In principle, a corresponding coating in the region of the channels also offers no specific advantages in terms of electrical conductivity, as these regions are generally at a distance from an adjacent MEA and its GDL.

In this context, it may be provided in particular that predominantly or exclusively the webs and in particular their outward-facing surfaces and/or surfaces that can be brought into contact with an adjacent structure, in particular a MEA or its GDL, are coated. This can particularly affect the web crests, which can form the highest or outermost regions of the webs. Alternatively, the coating can extend from the webs and in particular from the web crests up to a maximum of three quarters of the height, up to a maximum of half the height of the flow field and optionally up to a maximum of a quarter of the height, if measured from the webs and in particular their web crests in the direction of the base. In other words, in the latter case it can extend to a region that is at least a quarter, at least half or at least three quarters of the height away from a channel base or its lowest point.

The height of the flow field can correspond to the height of a respective web, which can, for example, consist of a web crest and two web flanks connected to it on both sides. The ends of the web flanks facing away from the web crest can merge into an adjacent channel and, in particular, the channel base. The channel base can form the lowest region of the flow field. The height can be measured orthogonally to a plate plane revealed here.

Optionally, the coating can be arranged on a flow field that extends on a surface of a separator plate that faces away from the other separator plate of the bipolar plate. Optionally, the coated separator plate surface is an outer surface of the bipolar plate. It is also possible for both outer surfaces of the bipolar plate to be coated in the region of their flow fields. In other words, the coating may be arranged in regions adjacent to a gas diffusion layer and via this to the MEA.

According to a further embodiment, the maximum thickness of the coating is at least 8 μm and/or at most 40 μm. For two-layer or multi-layer systems, an upper limit, in particular a summarizing upper limit of 40 μm may be advantageous, but in individual cases a greater total layer thickness of up to 60 μm may be preferable, depending on the application. It has been shown that the desired increase in electrical conductivity together with improved resistance of the coating can be reliably achieved within this value range, whereby the limited maximum layer thickness still ensures cost-effectiveness. In addition, much thicker coatings can have increased electrical resistance.

The substrate of the separator plates may have a thickness of less than 100 μm, optionally less than 80 μm, in some cases essentially 50 μm.

According to a further embodiment, the at least one flow field on at least one surface of the associated separator plate has, at least in certain regions, periodic surface structures with an average spatial period of less than 10 μm. Such surface structures can be formed according to any example, as known from DE 10 2021 202 214 A1 of the applicant. They can be accompanied by any of the advantages described there, in particular a further increase in electrical conductivity.

In this context, the coating can in particular be applied to a first surface of the associated separator plate and the periodic surface structures can be incorporated in a second surface that is opposite the first surface of the associated separator plate. The opposite surface can be, for example, the inner side of the bipolar plate as described above or the back of the separator plate.

In the following, embodiments of the present disclosure are explained with reference to the attached schematic figures. The same reference symbols can be used for similar features across all figures. Within a respective figure, only selected instances of a feature may be provided with the reference symbol assigned to this feature.

### BRIEF DESCRIPTION OF THE FIGURES

FIG. 1 shows a schematic perspective view of an electrochemical system with a plurality of bipolar plates arranged in a stack, each of which is designed according to an embodiment of the present disclosure.

FIG. 2 shows a schematic perspective view of two bipolar plates of the system according to FIG. 1 with a membrane electrode assembly (MEA) arranged between the bipolar plates.

FIG. 3A shows a schematic section through a region of an electrochemical system from FIG. 1 and FIG. 2.

FIG. 3B shows an enlarged view of a section IV from FIG. 3A.

FIG. 4 shows a schematic view of a cross-section through a region of an electrochemical system similar to FIG. 3A.

FIG. 5 shows a schematic cross-sectional view of a coating that can be used on the bipolar plates according to the embodiment example of FIGS. 1-4.

FIG. 6 shows a schematic cross-sectional view of another coating that can alternatively be used on the bipolar plates according to the embodiment example of FIGS. 1-4.

FIG. 7 shows a schematic cross-sectional view of yet another coating that can alternatively be used on the bipolar plates according to the embodiment example of FIGS. 1-4.

### DETAILED DESCRIPTION

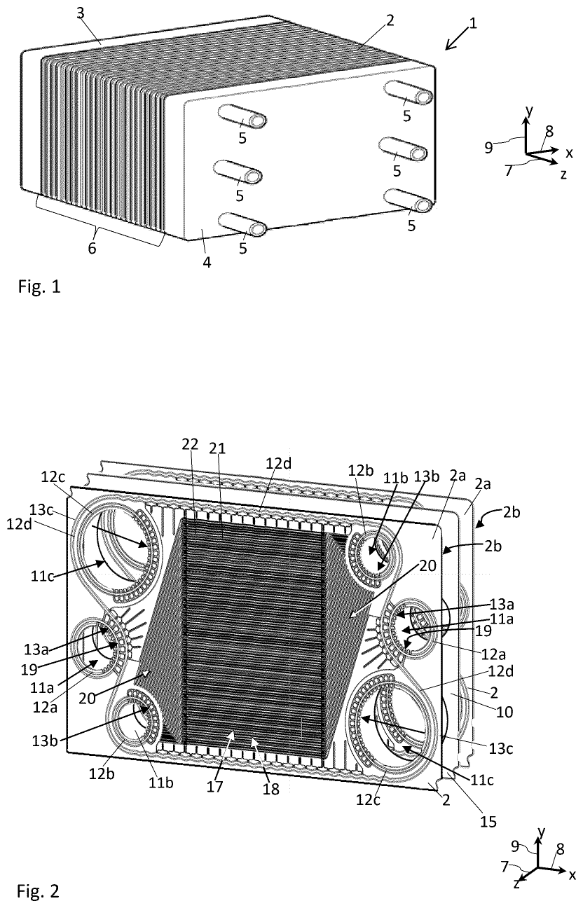

FIG. 1 shows an electrochemical system 1 with a plurality of identically constructed metallic bipolar plates 2 which are arranged in a stack 6 and are stacked along a z-direction 7. The bipolar plates 2 are designed according to embodiments of the present disclosure, as will be explained in more detail below, and in particular are coated according to the present disclosure.

The bipolar plates 2 of the stack 6 are clamped between two end plates 3, 4. The z-direction 7 is also called the stacking direction. In this example, system 1 is a fuel cell stack. Two adjacent bipolar plates 2, that is the facing separator plates 2a, 2b of each of these bipolar plates 2, of the stack 6 delimit an electrochemical cell, which is used, for example, to convert chemical energy into electrical energy. To form the electrochemical cells of system 1, a membrane electrode assembly (MEA) is arranged between adjacent bipolar plates 2 of the stack (see e.g. FIG. 2). The MEA typically contains at least one membrane, e.g. an electrolyte membrane. Furthermore, a gas diffusion layer (GDL) can be arranged on one or both surfaces of the MEA, which is adjacent to the surface of a separator plate 2a, 2b and in particular touches it.

In alternative embodiments, the system 1 can also be designed as an electrolyzer, electrochemical compressor or redox flow battery, for example. Bipolar plates can likewise be used in these electrochemical systems. The structure of these bipolar plates can then correspond to the structure of the bipolar plates 2 described in more detail here, in particular with regard to the coatings disclosed here. This applies even though the media fed onto or through the bipolar plates in an electrolyzer, an electrochemical compressor or a redox flow battery may differ from the media used for a fuel cell system.

Together with an x-axis 8 and a y-axis 9, the z-axis 7 spans a right-handed Cartesian coordinate system. The bipolar plates 2 each define a plate plane, each of the plate planes of the separator plates 2a, 2b of the bipolar plates 2 being oriented parallel to the x-y plane and thus perpendicular to the stacking direction, that is to the z-axis 7. The end plate 4 comprises a plurality of media connections 5, via which media can be supplied to the system 1 and via which media can be discharged from the system 1. These media that can be supplied to and discharged from system 1 can include, for example, fuels such as molecular hydrogen or methanol, reaction gases such as air or oxygen, reaction products such as water vapor or depleted fuels, or coolants such as water and/or glycol.

FIG. 2 shows a perspective view of two adjacent bipolar plates 2 of the electrochemical system of FIG. 1 as well as a membrane electrode assembly 10 arranged between these adjacent bipolar plates 2 and known from the prior art, whereby the MEA 10 in FIG. 2 is largely concealed by the bipolar plate 2 facing the observer and is only shown schematically, here in the form of its circumferential reinforcing edge 15. The bipolar plate 2 is formed of two separator plates 2a, 2b that are joined together in a materially bonded manner, of which only the first separator plate 2a facing towards the viewer is visible in FIG. 2, said first separator plate concealing the second separator plate 2b. The separator plates 2a, 2b can each be made from a metal sheet, e.g. a stainless-steel sheet. The separator plates 2a, 2b can, for example, be welded together along and at a distance from their edges, e.g. by laser welding joints.

In an electrochemically active region 18, the separator plates 2a, 2b have a flow field 17 with structures for guiding a reaction medium along the outside of the respective separator plate 2a, 2b. These structures are given in FIG. 2 by a plurality of webs 21 and channels 22 that extend between the webs 21 and are delimited by the webs 21. The present disclosure is not limited to flow fields with linear or straight webs and channels, but also includes other flow field geometries, such as geometries with undulating webs and channels.

The separator plates 2a, 2b have through-openings, which are aligned with one another and form the through-openings 11a-c of the bipolar plate 2. When stacking a plurality of bipolar plates of the type of bipolar plate 2, the through-openings 11a-c form conduits that extend through the stack 6 in the stacking direction (or z-direction 7) (see FIG. 1). Typically, each of the conduits formed by the through-openings 11a-c is fluidically connected to one of the media ports 5 in the end plate 4 of the system 1.

The separator plates 2a, 2b also each have a distribution or collection region 20. The distribution or collection region 20 comprises structures which are arranged to distribute a medium introduced into the distribution or collection region 20 from a first one of the two through-openings 11b via the active area 18 and/or to collect or direct a medium flowing from the active region 18 towards the second one of the through-openings 11b. In FIG. 2, the distribution structures of the distribution or collection region 20 are likewise provided by webs and by channels that extend between the webs and are delimited by the webs. In general, the elements 17, 18, 20, 21, 22 can therefore be understood as media-conducting embossed structures formed integrally, thus as one piece, with the separator plates 2a, 2b.

In order to seal off the through-openings 11a-c with respect to the interior of the stack 6 and with respect to the surrounding environment, the first separator plates 2a usually have sealing arrangements in the form of sealing beads 12a-c, which are each arranged around the through-openings 11a-c and in each case completely surround the through-openings 11a-c. On the rear side of the bipolar plates 2 that faces away from the viewer of FIG. 2, the second separator plates 2b have corresponding sealing beads for sealing off the through-openings 11a-c (not shown).

The sealing beads 11a-c each have passages 13a-c for passing fluid. Via the conduits formed by the through-openings 11a, coolant, for example, can be introduced into the stack 6 by means of the passages 13a or discharged from the stack 6, in particular into or out of the intermediate space 19 between the separator plates 2a, 2b. By contrast, the conduits formed by the through-openings 11b, 11c may be configured, via the passages 13b, 13c, to supply the electrochemical cells of the fuel cell stack 6 of the system 1 with fuel and with reaction gas and to discharge the reaction products from the stack. The media-guiding through-openings 11a-c are substantially parallel to the plate plane.

The first separator plates 2a typically also each have a further sealing bead 12d in the form of a perimeter bead, which runs around the flow field 17 of the active region 18, the distribution and/or collection region 20 and the through-openings 11b, 11c and seals these from the through-opening 11a, i.e. from the coolant circuit and from the external environment of the system 1. The second separator plates 2b each comprise corresponding perimeter beads.

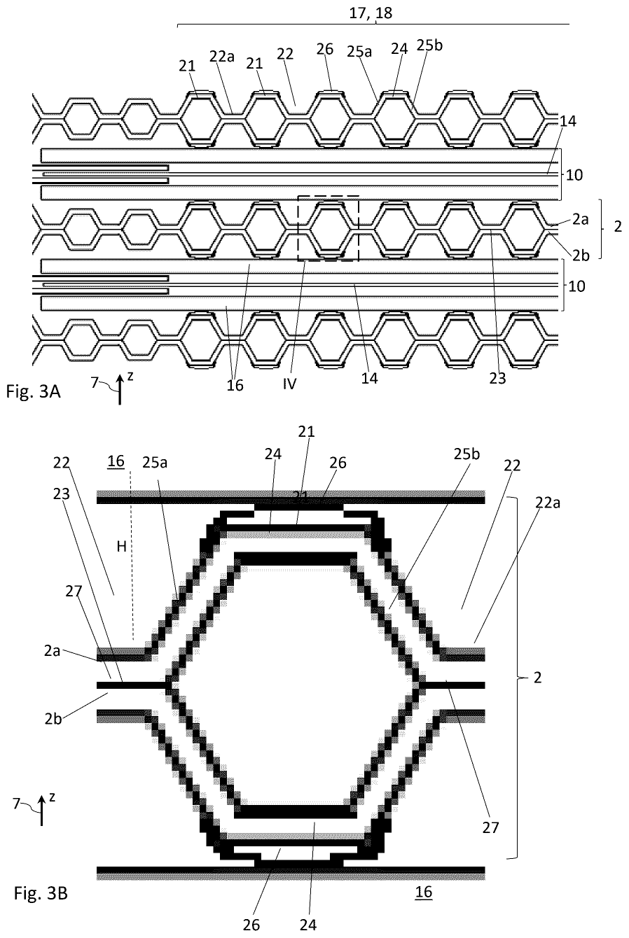

FIG. 3A and FIG. 3B each schematically show a section through of a region of the electrochemical system 1 of FIG. 1 and FIG. 2, with the sectional plane in each case aligned in the z-direction and thus perpendicular to the plate planes of the bipolar plates 2. Furthermore, the sectional plane runs through, that is in the region of, the flow fields 17 of the bipolar plate 2.

FIGS. 3A and 3B again show the first metallic separator plate 2a described above and the second metallic separator plate 2b described above, which are joined together to form a respective bipolar plate 2. Each metallic separator plate 2a, 2b can have a thickness of its metallic substrate of about 75 μm. The structures for media conduction can be seen along the outer surfaces and in the flow field 17 of the bipolar plates 2 in the form of the webs 21 and the channels 22 bounded by the webs 21. The two separator plates 2a, 2b lie on top of each other in a contact region 23 and can be connected to each other there, for example by means of laser welding seams. The metallic separator plates 2a, 2b in particular at least their respective substrates, can, for example, be made of stainless steel, such as a non-coated stainless steel and/or a titanium alloy and/or a stainless-steel core with at least one surface made of a titanium alloy. Non-coated stainless steel is particularly advantageous for fuel cell applications, a stainless-steel core with titanium coating for use in electrolyzers and electrochemical compressors.

In the section shown in FIG. 3A, a central bipolar plate 2 is shown arranged between two membrane electrode units 10. The MEA 10 typically comprises a membrane 14, e.g. an electrolyte membrane, and a fluid-sealing edge area 15 connected to the membrane, as well as other layers. For example, the fluid-sealing edge area 15 can be bonded to the membrane 14 and possibly other layers, e.g. by an adhesive bond or by lamination.

The membrane 14 of the MEA 10 extends in each case at least over or along the active region(s) 18 of the adjacent bipolar plates 2 and there enables a proton transfer over or through the membrane 14. The membrane 14 does not extend into the distribution or collection region 20 (cf. FIG. 2). The edge area 15 of the MEA 10 is used to position, fasten and seal the membrane 14 between the adjacent bipolar plates 2.

Furthermore, gas diffusion layers 16 of the MEA 10 can be additionally arranged in the active region 18. The gas diffusion layers 16 enable a flow across the membrane 14 over the largest possible region of the surface of the membrane 14 and can thus improve the proton transfer via the membrane 14. The gas diffusion layers 16 can, for example, be arranged on both sides of the membrane 14 in the active region 18 between the adjacent separator plates 2. The gas diffusion layers 16 can, for example, be formed from an electrically conductive nonwoven material or comprise an electrically conductive nonwoven material. The electrically conductive nonwoven material may be a metal nonwoven material or a carbon nonwoven material.

FIG. 3B shows an enlarged view of section IV from FIG. 3A. This comprises one of the webs 21 and parts of the adjacent channels 22 of the respective separator plates 2a, 2b that form the central bipolar plate 2 in FIG. 3A. The reference signs are primarily provided for the upper separator plate 2a, whereby the lower separator plate 2b in the active area 18 is designed in principle in the same way or mirror-symmetrically. Similarly, the webs 21 and channels 22 of a respective bipolar plate 2 within the flow field 17 are essentially of the same design, so that the web 21 and the channels 22 from FIG. 3B are correspondingly representative of the entire flow field 17.

It can be seen that the webs 21 of FIG. 3B each have a web crest 24 running along the main direction of extension of the respective web 21. The main direction of extension is perpendicular to the plate plane. Furthermore, the webs 21 each have a first and a second web flank which can also be considered as side walls 25a and 25b, each of which adjoins the web crest 24 and also extends along the main direction of extension.

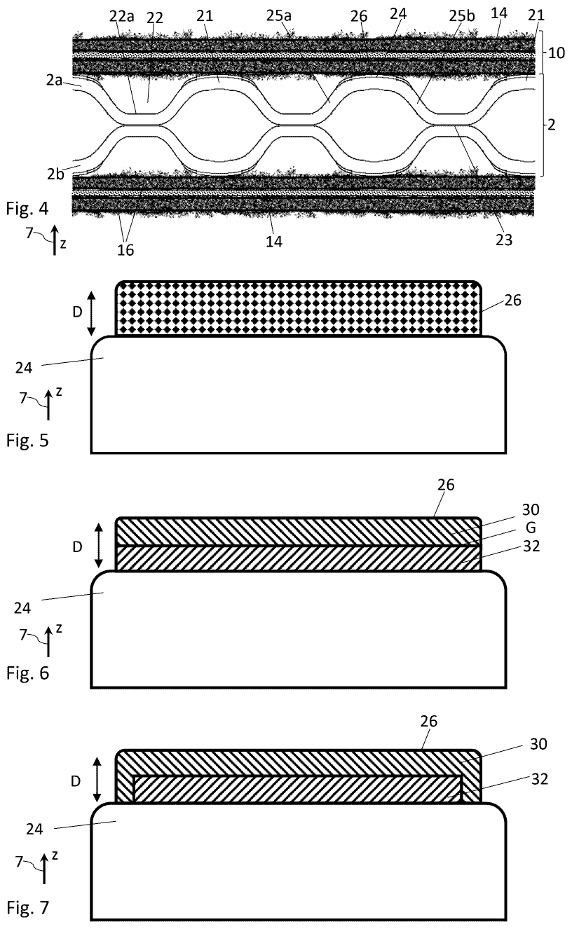

The web crests shown in FIGS. 3A and 3B have no curvature, thus they are flat, but can alternatively also have a curvature with a radius of, for example, at least 0.5 mm, optionally at least 1 mm, as shown below in FIG. 4.

Optionally, the web flanks 25a and 25b of a respective web 21 each have a minimum angle to the zero plane in the range from 15° to 75°, optionally from 25° to 65°. Here, the zero plane is understood to be the main extension plane and/or plate plane of the metallic separator plate 2a or 2b.

Optionally, the web flanks 25a and 25b of a respective web 21 are tangentially connected to the web crest 24 of the respective web 21 with a radius which is at least 0.05 mm, optionally at least 0.15 mm, this radius not being recognizable in the schematic representation of FIGS. 3A and 3B. This radius can be considered to be part of the web flank 25a, 25b.

Optionally, the web flanks 25a and 25b of a respective web 21 are each tangentially connected to the base 22a of the channel 22 adjacent to or bounded by the respective web flank 25a, 25b with a radius which is at least 0.05 mm, optionally at least 0.15 mm, this radius not being recognizable in the schematic representation of FIGS. 3A and 3B. This radius can also be considered to be part of the web flank 25a, 25b.

A height axis H of a web 21 and of the flow field 17 is shown as an example in FIG. 3B and runs orthogonally to the zero plane or main extension plane of the metallic separator plates 2a, 2b and thus parallel to the z-axis. The height of a respective web 21 can be measured along the height axis H, starting from the base 22a of the channel 22 up to the web crest 24. The channel base 22a and the web flank 25a, 25b define the channel 22, which can guide a fluid flow along the flow field 17. At least the web crest 24 can form a structure separating two channels 22 in each case and/or can accordingly be understood as a separating web. Alternatively, the flanks 25a, 25b or at least one height section thereof can be understood and designated as components of the channel 22, for example as channel flanks. Similarly, the web crest 24 could be understood and described as a web or part of such.

At least the web crests 24 are each provided with a coating 26, which may be formed according to any of the variants disclosed herein, see in particular the discussion of FIGS. 5-7 below. In the example shown, only the web crests 24 are provided with the coating 26. However, a targeted or process-related coating of the web flanks 25a, 25b can be omitted or is at least limited to one of the previously disclosed regions and in particular one of the previously disclosed height levels.

Opposite the channel bases 22a, i.e. on an inner side of the separator plate 2a, an exemplary region 27 is marked, in which an optional surface structuring of the aforementioned type can be formed. Such a surface structure can also be present in the case of the lower separator plate 2b.

It is shown that the coating 26 is in direct contact with the adjacent GDL 16. This results in a defined interaction of the coating 26 with the fibers of the gas diffusion layer 16, in particular in the form of the creation of an electrically conductive connection. It is also possible for sections of the gas diffusion layer 16 to penetrate the coating 26.

FIG. 4 schematically shows a section through a region of an electrochemical system 1 comparable to FIG. 1 and FIG. 2, whereby the sectional plane is aligned in the z-direction and thus perpendicular to the plate planes of the bipolar plates 2. Furthermore, the sectional plane extends through or in the region of, the flow fields 17 of the bipolar plate 2. Unlike in the embodiment in FIGS. 3A and 3B, the web crests 21 are not flat here, but have a slight curvature, which nevertheless enables good contact between the coating 26 and the GDL 16. In FIG. 4, the transition radii between the web flanks 25a, 25b and the web crests 24 or the base 22a of the channels 22 are also clearly recognizable.

With reference to FIGS. 5-7, coatings 26 according to embodiments of the present disclosure are explained which, in addition to graphite and carbon black, also comprise at least one binder for improving the resistance of the coatings 26. FIGS. 5-7 show sections of a bipolar plate 2 and, more precisely, of a single web crest 24, analogous to the view in FIG. 3B, whereby all other web crests 24 within the flow field 17 can also be formed analogously.

The coating 26 is applied with a thickness D and essentially completely covers the web crest 24 and, more precisely, its outer side. The thickness D can have any value disclosed in this document.

In the example of FIG. 5, the coating 26 comprises a graphite carbon black mixture and at least one binder dispersed therein, for example one or two binders. The proportions of these ingredients may be selected according to any examples disclosed herein. The binder does not include graphite or carbon black. The at least one binder is formed according to any one of the examples disclosed herein, for example comprising PA or PAI. Optionally, a binder contains only a single material and not a mixture of materials or only a mixture of materials from a single material group, for example a mixture of different types of PA (for example a mixture of PA 6 and PA 12) or of different types of PAI. The coating 26 can be applied according to any example of the prior art, for example by roller printing, pad printing or by spraying, in particular with nozzles that are designed to selectively spray the webs. Once applied, it can dry and/or harden.

It has been shown that the addition of the binder(s) can improve adhesion of the coating 26 to the web crest 24 and prevent or at least severely limit the formation of capillaries within the coating 26. In particular, this can reduce the risk of water and/or other substances penetrating into an interface or contact surface between the coating 26 and the web crest 24 of the separator plate substrate.

FIG. 6 shows a further example embodiment in which the coating 26 has a two-layer structure. A first layer 30 forms an outermost layer, which can, for example, come into contact with a GDL (not shown). The first layer 30 is not in direct physical contact with the web crest 24 of the separator plate substrate. A second layer 32 is located between the first layer 30 and the web crest 24 of the separator plate substrate and is in direct physical contact with the latter. Accordingly, the coating 26 is applied in two layers, whereby the second layer 32 is first applied to the web crest 24 of the separator plate substrate, where it is at least intermediately dried and/or can already be at least partially cured. The first layer 30 is then applied to the second layer 32, whereupon the entire coating 26 can be heated, whereby the thermoplastic binder(s) can be melted or a thermoset binder can be cured.

The first layer 30 and the second layer 32 differ in terms of their material composition. In particular, they each have a binder that is not present in the corresponding other layer 30, 32. For example, the first layer 30 has PA, but not PAI, and the second layer 32 has PAI, but not PA. The PA or PAI material can also be provided as a mixture of different types of PA or PAI.

Even after melting or hardening, the first and second layers 30, 32 can be distinguishable as such, even if they may at least partially merge into and/or blend with one another at their interface G. For example, in an interface to a GDL (not shown), PA may be predominantly or exclusively present as a binder even after melting or curing and PAI may be predominantly or exclusively present as a binder in the interface to the metallic web crest 24. It has been shown that the PAI in the internal coating sections is particularly effective in improving the electrical conductivity of the coating 26 and separator plate 2a, 2b, whereas the PA in the external coating sections can effectively prevent the ingress of water or other substances and thus the premature detachment of the coating 26.

It should be noted that a reverse arrangement of predominantly PAI in the outer layer 30 and predominantly PA in the inner layer 32 can also be provided. In such a case, for example, the adhesion of the coating 26 to the metallic web crest 24 can be selectively increased by the PA.

In an alternative embodiment, the first layer 30 may comprise a first binder mixture in addition to a graphite carbon black mixture and the second layer 32 may comprise a second binder mixture. By way of example, the first layer 30 has a first quantity ratio of PA and PAI and the second layer has a second, different quantity ratio of PA and PAI.

In the example shown in FIG. 6, the layers 30 and 32 are arranged essentially congruently on top of each other. Their end faces (that point to the left and right in FIG. 6), which for example run essentially orthogonally to a plane of the web crest 24 and/or along the thickness dimension D, are exposed in each case. Thus, water can come into direct contact with at least these end faces of the lower second layer 32.

The example in FIG. 7 is in principle analogous to that in FIG. 6, with the only difference being that the first layer 30 completely encloses the outer surfaces of the second layer 32, which are initially exposed after it is applied. This also includes the end faces which are exposed in FIG. 6. In other words, the second layer 32 is completely shielded from the environment by the first layer 30 in cooperation with the web crest 24 and/or is embedded in the first layer 30. In this way, the contact of this second layer 32 with water and/or other substances is specifically suppressed in order to further reduce the risk of the coating 26 peeling off.

As used herein, the terms “approximately,” “substantially,” “essentially,” or “about” may be construed to mean plus or minus five percent unless otherwise specified.

1. A metallic bipolar plate for an electrochemical system,
wherein the bipolar plate comprises two separator plates and each of the separator plates has a flow field,
wherein at least one of the flow fields has a coating on at least one surface of the associated separator plate, at least in sections, and
wherein the coating comprises:
at least 50% by weight and/or at most 95% by weight of a graphite-carbon black mixture, and
at least 5% by weight and/or at most 31% by weight of one binder or of a combination of several binders.

2. The bipolar plate according to claim 1,
wherein the coating comprises at least two different binders and has a single-layer structure.

3. The bipolar plate according to claim 1,
wherein the coating comprises at least two different binders and has at least two layers; and
wherein a binder is present in at least one of the layers and is not present in one of the other layers.

4. The bipolar plate according to claim 3,
wherein each of the layers comprises exactly one binder.

5. The bipolar plate according to claim 3,
wherein one of the binders is a thermoset or an amorphous first thermoplastic and wherein the other binder is a second thermoplastic.

6. The bipolar plate according to claim 5,
where the second thermoplastic is partially crystalline.

7. The bipolar plate according to claim 5,
wherein one of the binders comprises polyamide, PA, and the other binder comprises polyamideimide, PAI.

8. The bipolar plate according to claim 7,
wherein the coating contains at least 3% by weight and at most 30% by weight PAI and/or at least 1% by weight and at most 12% by weight PA.

9. The bipolar plate according to claim 7,
wherein the coating comprises PAI as the thermoset or amorphous first thermoplastic and PA as the second thermoplastic.

10. The bipolar plate according to claim 1,
wherein the graphite/carbon black mixture has a carbon black/graphite ratio of at least 1:1 up to and including 1:25.

11. The bipolar plate according to claim 1,
whereby graphite particles of the graphite-carbon black mixture are platelet-shaped.

12. The bipolar plate according to claim 1,
wherein the flow field has a plurality of channels and webs extending between the channels,
wherein the coating is applied at least to the webs; and/or
wherein at least channel bases of the channels are free of the coating.

13. The bipolar plate according to claim 12,
wherein the flow field is arranged on a surface of a separator plate that faces away from the other separator plate of the bipolar plate.

14. The bipolar plate according to claim 1,
wherein a maximum thickness of the coating is at least 8 μm and/or at most 40 μm.

15. The bipolar plate according to claim 1,
wherein the flow field has, on at least one surface of the associated separator plate, at least in certain regions, periodic surface structures with an average spatial period of less than 10 μm.

16. The bipolar plate according to claim 15,
wherein the coating is applied to a first surface of the associated separator plate and the periodic surface structures are applied to a second surface that is opposite the first surface of the associated separator plate.
